(19) United States
(12) Patent Application Publication
(10) Pub. No.: US 2008/0270314 A1
(43) Pub. Date: Oct. 30, 2008

(54) INTEGRATED APPROACH IN AN END-TO-END PROCESS FOR MERGERS AND ACQUISITIONS

(75) Inventors: Richard Birney, Fishkill, NY (US); Lara Cumberland, Greenwich, CT (US); Shyarsh Desai, Chappaqua, NY (US); David L. Johnson, Ridgefield, CT (US); Akiko M. Miyashita, Ridgefield, CT (US); Kenneth B. Posey, Bronx, NY (US); David C. Sun, San Mateo, CA (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/128,793

(22) Filed: May 29, 2008

Related U.S. Application Data
(63) Continuation of application No. 11/150,964, filed on Jun. 13, 2005.

(51) Int. Cl. G06Q 10/00

(52) U.S. Cl. 705/80

(57) ABSTRACT

Disclosed is a method, system and service for developing an end-to-end process for managing acquisitions including, developing strategies and identify an appropriate company for acquisition, managing a transaction and negotiating a deal, integrating an acquired acquisition, and tracking performance against defined business case targets and milestones.

### CROSS-REFERENCE TO RELATED APPLICATION

This application is a continuation of U.S. patent application Ser. No. 11/150,964, filed Jun. 13, 2005, the disclosure of which is incorporated by reference herein in its entirety.

### FIELD OF THE INVENTION

The invention relates to an integrated approach in an end-to-end process for mergers and acquisitions. More specifically, an end-to-end process for managing acquisitions within an organization: from working pro-actively with the business units to develop strategies and identify appropriate targets, to managing the transaction and negotiating the deal, to integrating acquired companies, and tracking performance against defined business case targets and milestones.

### BACKGROUND

U.S. Patent Application 2002/0169649A1 disclose systems and methods that facilitate integration of one corporate entity into another corporate entity are described herein. In one embodiment, a method in a computer for generating an acquisition integration project plan includes displaying a plurality of pre-defined integration events based upon at least one user selected integration area, each pre-defined integration event being associated with a phase in an acquisition process, displaying at least one user selected, pre-defined integration event for each user selected integration area, displaying at least one of a name of a person responsible, a due date, a completion percentage, and a commentary for each user selected, pre-defined integration event, and storing the user selected, pre-defined integration events and corresponding integration areas as an acquisition integration project plan.

U.S. Patent Application 2004/0024627 A1 a discloses Business Technology Relationship Model (BTRM) is a method for abstracting and modeling the relationships that exist between technical infrastructure components and specific business processes, resulting in a proprietary Business Technology Relationship Protocol. The method defines a dependency approach to technical infrastructure delivery and management by creating the 13 Layer BTRM Dependency/Impact Hierarchy, a modeled understanding of the dependencies that specific business processes have on specific technical infrastructure components, including the interdependencies between modeled business and technical objects. When the resulting Relationship Protocol is placed into software, the BTRM Method improves the delivery and management of technology infrastructure and technology support services spanning a diverse set of industries and business disciplines.

U.S. Patent Application 2004/0181422 A1 discloses an economic analysis model (see FIG. 1) including a suite of software based modules designed to assist deconstruction and recycling of large scale industrial facilities at every stage of the effort including but not limited, to assessment (102) and pricing, acquisition, production planning, cost reduction and revenue enhancement, as well as updating a historical database to store data to these stages. The invention is particularly useful with deconstruction projects involving large-scale, complex industrial facilities such as ships, refineries, floating oil rig platforms, chemical and nuclear plants.

U.S. Patent Application 2004/0193432 A1 discloses a system and method for optimizing acquisitions simultaneously among more than one project a time. Acquisitions are assembled appropriately as independent or larger packages. Components for acquisitions are broken out of the overall project and combined with like components of other projects. Each component package is then submitted to an appropriate market for the appropriate type of procurement. After procurement, components are reassembled into their original projects and distributed back into the acquisitions. This method allows more sellers to participate in the process and, at the same time, allow buyers to reap the benefit of volume transactions in their dealings with sellers. The integrity of the acquisition is maintained.

U.S. Patent Application 2002/0046053 A1 discloses a web based system maintained at a central server and accessible to users over the Internet for defining financial risks and risk mitigation needs of a user based upon profile data of the user. The system includes a means for inputting user profile data into the system; means for accumulating the input data in databases to enable analysis of said data; and means for analyzing the profile data and for identifying financial risks associated with said profile data. The system also provides a means for identifying financial products which will provide solutions to mitigate such-risks as well as a means for specifying the cost to acquire or purchase those financial products. Finally the invention includes means for binding in real time a commitment for the purchase and sale of financial products; and a means for processing a transaction to implement the purchase and sale of the financial products.

U.S. Patent Application 2002/0046187 A1 discloses an automated system utilizes a networked computer system such as the Internet for initiating and managing mergers and acquisitions of businesses between third parties. A host computer system connected to the network hosts a site operated on behalf an investment banking firm. The site includes a secured login area, a seller registration area, a buyer registration area, a unique home page area for each registered seller and registered buyer, and a secure administration area. In each registration area a user enters profile information and is registered as a registered seller or registered buyer. The registered seller also provides detailed confidential information about a business to be offered for sale in addition to the seller profile. The unique home page area displays information and communications relating to opportunities matching the profile for that registered seller or buyer. In the secure administration area, a user for the investment banking firm tracks the initiation and management of matching opportunities and information, history, status and communications among registered sellers and registered buyers. A management program executes on the host computer and interfaces with the site to coordinate communications among registered sellers, registered buyers and the investment banking firm in response to actions at the site. The automated system allows registered sellers to selectively control the transmission of confidential information of the registered seller to potential registered buyers and allows registered buyers to generate expressions of interest and offers for the businesses of registered sellers using the site as the communication medium for such actions.

U.S. Patent Application 2001/0011222 A1 discloses access to procurement (purchasing and contract) data is provided to many users by a system that connects a core procurement system used by procurement professionals in a procuring agency to a public computer network like the Internet. At least one Web/application server connected to the core procurement system by a LAN or WAN provides, access to non-procurement personnel in the procuring agency, non-agency personnel in the same organization, vendors, grantees and others, based on security procedures established by an authorized procurement officer in the procuring agency. Users of the system connected via the Internet use Java-enabled Web browsers to create, receive and send procurement documents and data via XML formatted documents. Field buyers connected via a mobile link use portable computers to send and receive similar data. Each user can access a reference library of information sources, such as the FAR, DOL wage rates, etc., in XML format to obtain procurement regulations and required data elements. Procurement documents and data include, but are not limited to, agreements, contracts, grants, solicitations, bids, catalog purchases, announcements, approvals, vendor profile and performance data, interagency agreements, and acquisition plans. All resulting procurement management data is integrated into the core procurement system, where procurement managers exert managerial procurement controls and generate required reports.

U.S. Patent Application 2002/0035499 A1 discloses an invention that is related to patent-related tools, and methodologies involving those tools, for assisting in all stages of the merger and acquisition process. The IPAM server may be used in conjunction with the tools and methodologies to aid in the merger and acquisition process. These tools or methods include, but are not limited to, a topographic map, a technology classification, a SIC classification, a radar diagram, a patent citation tree, a citation root tree, a citation count report, a citation frequency graph, a citation frequency report, a patent count/year, an application count/year, a patent aging graph, a U.S. primary class/subclass, an international patent class, an assignee patent count report by primary class/subclass, a patent count graph by number of patents, a top assignees primary class/subclass by percent of total, a months to issue patents, a features grouping, a document annotation, an inventor patent count/assignee, an inventor patent count graph, and inventor data.

Currently, the prior art fails to effectively address:

an effective deal management system and governance throughout the M&A process to ensure accountability and clear ownership and roles and responsibilities;

communication and hand-offs between phases and organizations;

formal feedback mechanisms linking all phases of the M&A process; and

established organization support and centers of expertise to support specific steps in the M&A process.

### SUMMARY OF THE INVENTION

An exemplary feature of this invention is a method of an integrated approach in a business environment. The method consists of developing an end-to-end process for managing acquisitions including developing strategies and identifying an appropriate company for acquisition. The method further consists of managing a transaction and negotiating a deal, integrating an acquired acquisition, and tracking performance against defined business case targets and milestones.

Another exemplary feature of this invention is a method that creates a proactive business development plan as part the development of strategies.

A further exemplary feature of this invention is a method which uses a transaction execution center and further incorporates further method aspects of conducting a due diligence process, developing a business case and model, structuring and negotiating the terms of a transaction, and developing and maintaining all agreements for said transaction.

Yet another exemplary feature of this invention is a method which uses an integration objectives and approach (IOA) tool as part of a final approval process.

Another exemplary feature of this invention is a method which uses a minority investment database.

A further exemplary feature of this invention is a method which uses an acquisition integration center to provide various services thereby enabling a business unit to perform the necessary acquisition steps from concept approval to final approval.

Yet another exemplary feature of this invention is a method which selects an integration executive for integrating the acquired company and for creating deliverables supporting a business case.

Yet another exemplary feature of this invention is a method which uses integration team support elements including conducting a transition executive bootcamp.

Still another exemplary feature of this invention is a method which uses integration execution systems and tools to enable a repeatable process that incorporates information learned from prior acquisitions.

Various other objects, exemplary features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF THE DRAWINGS

The foregoing and other objects, aspects, and advantages will be better understood from the following non-limiting detailed description of preferred embodiments of the invention with reference to the drawings that include the following:

FIG. 1 illustrates an overall flow of a lifecycle embodying the present invention.

FIG. 2 illustrates an integrated approach in an end-to-end process according to an embodiment of the present invention.

FIG. 3 illustrates a first set of sub-processes of an integrated approach in an end-to-end process according to an embodiment of the present invention.

FIG. 4 illustrates a second set of sub-processes of an integrated approach in an end-to-end process according to an embodiment of the present invention

FIG. 5 illustrates a third set of sub-processes of an integrated approach in an end-to-end process according to an embodiment of the present invention

FIG. 6 illustrates yet another integrated approach in an end-to-end process according to an embodiment of the present invention.

FIGS. 7-13 show flow charts for certain aspects an integrated approach in an end-to-end process according to an embodiment of the present invention

FIGS. 14 and 15 illustrate a hardware and software implementation for using an integrated approach in an end-to-end process according to an embodiment of the present invention.

FIGS. 16 and 17 illustrate a software deployment implementation for using an integrated approach in an end-to-end process according to an embodiment of the present invention.

FIGS. 18A, 18B and 18C illustrate still another software deployment implementation for using an integrated approach in an end-to-end process according to an embodiment of the present invention.

### DETAILED DESCRIPTION

Set forth below is a description of the methods and systems for an integrated, comprehensive approach to managing the complete mergers and acquisitions (M&A) lifecycle within an organization. This approach to the M&A lifecycle includes all required steps in the process from working pro-actively with the business units to develop strategies and identify appropriate targets, to managing the transaction and negotiating the deal, to integrating acquired companies and assets, to tracking performance against defined business case targets and milestones.

The term “M&A lifecycle” used herein describes the specific approach and elements associated with this claim. The integrated approach to managing the M&A lifecycle ensures deals are appropriately considered, controlled, completed, monitored and measured for deal success, regardless of the type of transaction. It enables M&A deals to be consistently and continuously evaluated, negotiated, purchased, integrated and operated to increase the likelihood of deal success.

The term “M&A deal” is used herein to describe M&A activity undertaken by an organization, including but not limited to mergers between companies, acquisitions of companies, parts of companies, assets, or company portfolios, and minority investments.

The term “integrated” is used herein to describe the linkage, interaction, and relationship between various elements of the method as it relates to the M&A deal lifecycle from growth strategy formulation to deal concept and execution, to post-acquisition performance evaluation. The method is integrated through well defined, repeatable processes, established deal management systems and approval stages, supporting organizational structures, and a process and mechanism to capture learning and enable continuous improvement in all elements of the method.

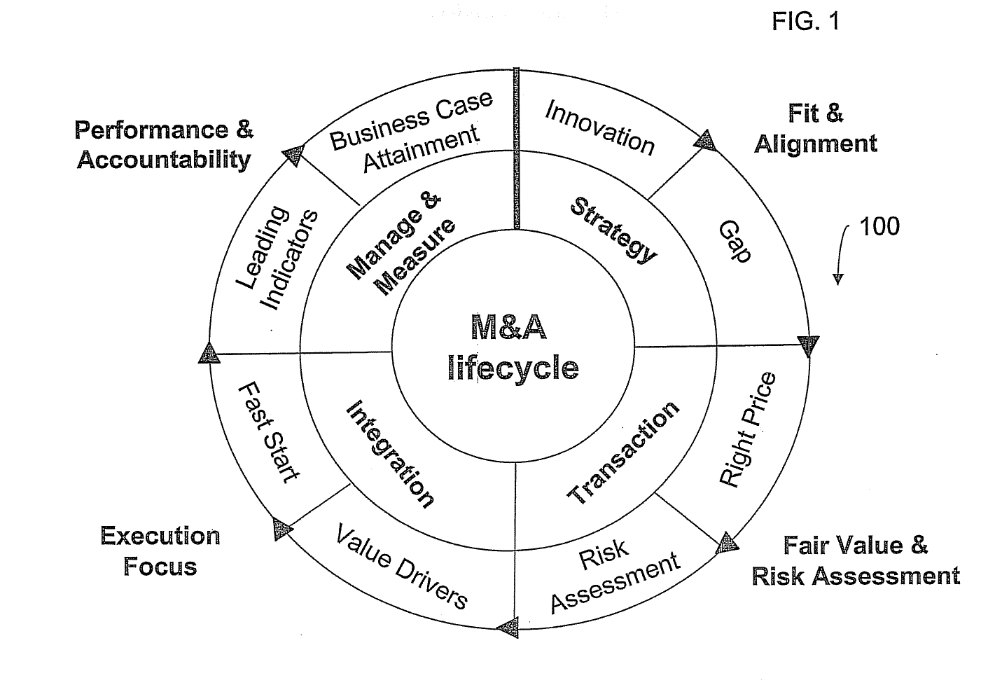

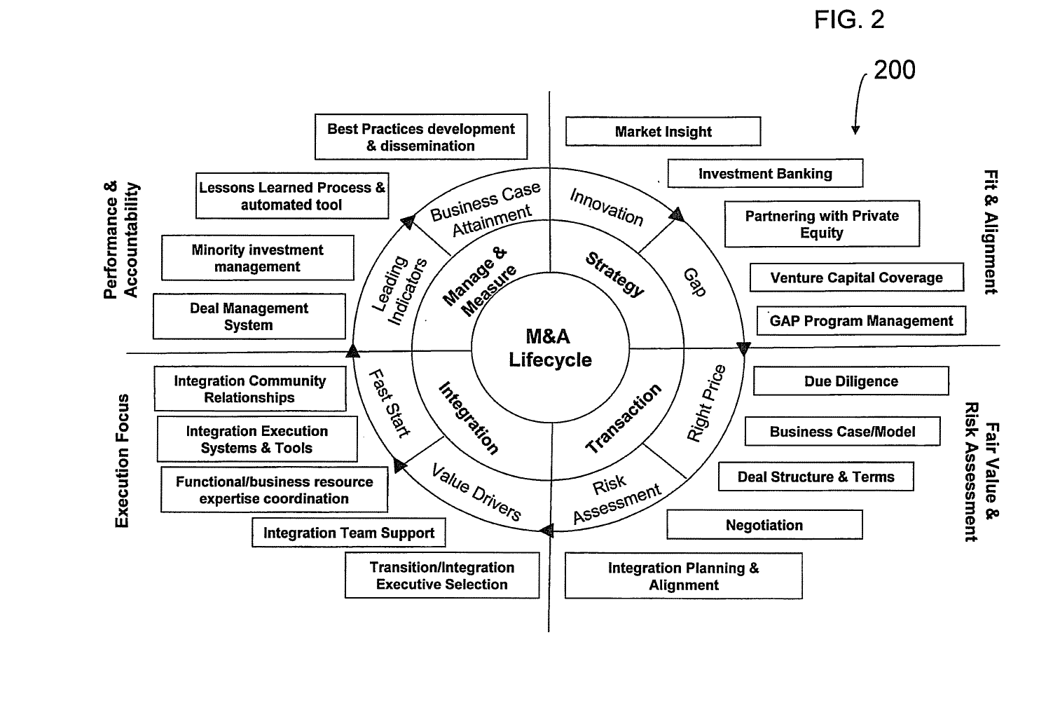

FIGS. 1 and 2 illustrate an integrated view of the M&A lifecycle 100. Proper execution of the described elements through the lifecycle will enable the four critical success areas for M&A deal success: Fit and Alignment, Fair Value and Risk Assessment, Execution Focus, and Performance and Accountability. Furthermore, the lifecycle is described in a circular pattern to emphasize the necessary continuous feedback loop between elements in the process, representing ongoing learning and process improvement and refinement with each new deal that travels through the lifecycle.

In the Strategy phase of the M&A lifecycle, proper Fit and Alignment of any potential M&A deal is the primary focus. Innovation is critical in both the development of programs to identify M&A opportunities and in the types of opportunities themselves (i.e., new markets, new business model, etc.). In addition, strategically filling identified gaps in a company's capabilities is also a critical component of the Strategy phase. More detail on the processes and key activities required to implement the Strategy phase of the M&A lifecycle is included below.

In the Transaction phase, the primary focus is on establishing Fair Value for the M&A deal and conducting a thorough Risk Assessment, relating both to the transaction itself and the future integration of the acquired company into the acquiring company. More detail on the processes and key activities required to implement the Transaction phase of the M&A lifecycle is included below.

In the Integration phase, Execution Focus is critical to success. Value Drivers are created around the deal Strategy and Transaction assumptions to guide the Integration. All initial integration support is focused on a Fast Start, creating early momentum particularly for sales and development if required. This focus is critical as M&A deals rarely recover from a slow first quarter after close. More detail on the processes and key activities required to implement the Integration phase of the M&A lifecycle are included below.

In the Manage and Measure phase, the primary focus is on Performance and Accountability. Measuring M&A deals against the established Business Case and Leading Indicators (i.e., key milestones, etc.) is critical to understanding if the deal is being executed successfully or not (i.e., is delivering on the committed financial business case and on the strategic rationale for the deal). More detail on the processes and key activities required to implement the Manage and Measure phase of the M&A lifecycle are included below.

FIG. 2 illustrates the major processes and key activities associated with each of the four key phases of the M&A lifecycle 200. Even if each phase in the lifecycle is conducted appropriately, the result may be insufficient to support a successful M&A deal. Every process and activity in one phase of the lifecycle must feed into the next and guide its objectives to support a deal. This integrated approach to the M&A lifecycle enables best practices and lessons learned identified through managing and measuring the deal throughout the M&A lifecycle to be effectively fed back and incorporated into the Strategy, Transaction and Integration methods and systems on an ongoing basis to ensure continuous improvement to processes and to institutionalize knowledge and practices in the organization.

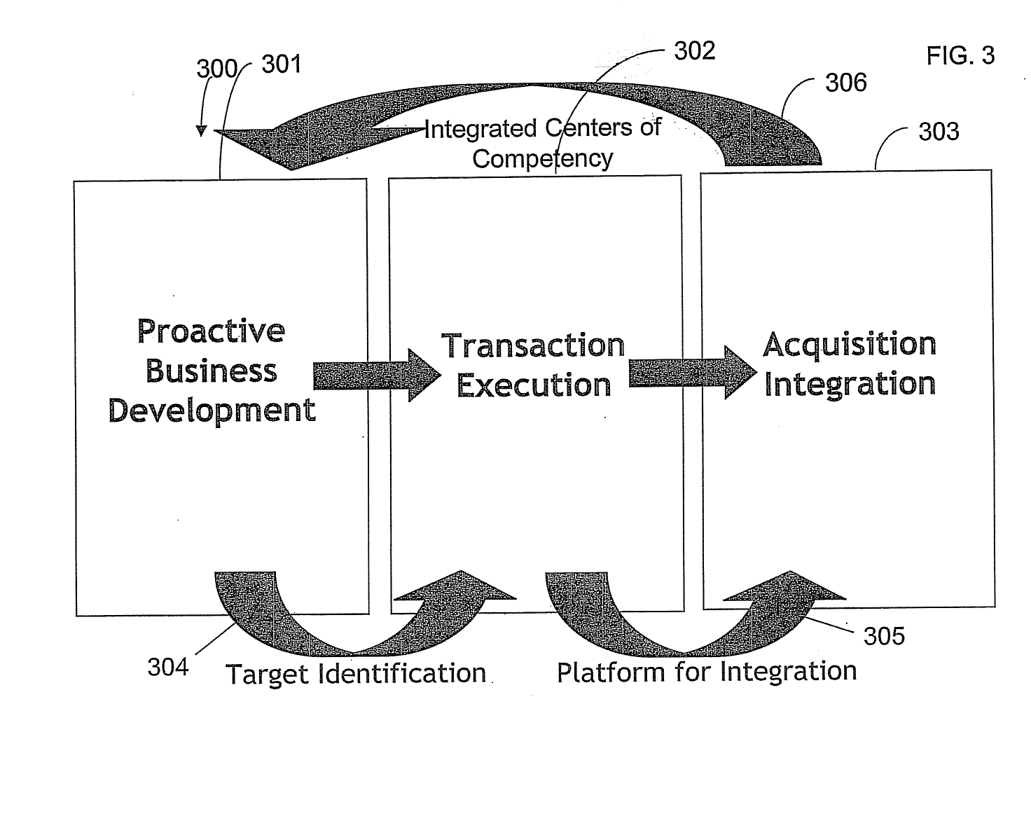

Furthermore, effective execution of the M&A lifecycle methods and systems requires three integrated centers of competency as shown in FIG. 3. These centers of competency execute the process and are critical to developing knowledge, leveraging internal experiences and external insights and creating expertise around the methods and systems that make up the M&A lifecycle. These centers of competency are most effective when contained within a single department or management structure (e.g., Corporate Development) within an organization to facilitate communication between the centers. They can, however, also be contained in multiple departments and be duplicated, as required, across different business units. Each center is dedicated to a specific set of processes and activities as described below and, as with the M&A lifecycle itself, these groups must be tightly integrated through common objectives and processes to be effective.

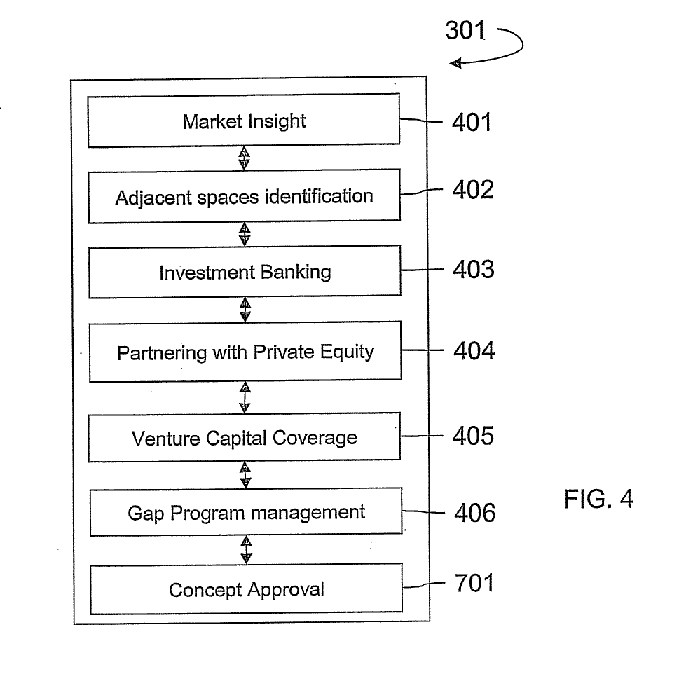

Proactive Business Development 301 supports the Strategy phase of the M&A lifecycle by working with company business units to develop strategies and identify appropriate targets, Target Identification 304 through collection of specific knowledge about the business, industry, and competition and through a series of focused initiatives as described in FIG. 4.

To gain Market Insight 401, the Proactive Business Development center of competency uses a disciplined approach of industry taxonomies to assess broad opportunities in an industry and tactical gaps to be filled in the company's existing portfolio. Key to this approach is to understand the profit pools and whether the optimal approach would be for the company to build, partner or acquire. Proactive Business Development then uses their investment banking 403 ecosystem to further refine or validate the market based view for these opportunities.

Related to this effort is the identification of Adjacent Spaces 402 that are attractive pools of profit that reside outside a company's domain of core skills and assets but represent significant synergies with existing lines of business. The Proactive Business Development center of competency brings together sponsors from the different business units and relevant industries to target these opportunities, including defining new management, incentive and financial structures in support of these Adjacent Spaces. Often these opportunities are pursued in partnership with the financial sponsor community or other strategic stakeholders to reduce risk and allow each stakeholder to target skills and assets that are of greatest value to them.

The Proactive Business Development center of competency 301 also manages a framework for partnering with Private Equity (“PE”) to drive revenue growth firms known as Companies in Transition 404. They engage with PE firms and Leveraged Buy Out institutions pre-acquisition (in the Strategy phase of the M&A lifecycle) to assess incremental value creation potential in a particular target. This value is determined by leveraging transformation and operations experiences in outsourcing and management of business processes and IT infrastructure.

Each PE firm is assigned a relationship coverage executive that manages the firm on a global basis. This individual works closely with line executives from specific industries within a company to create ideas for partnership with the PE firms. The team then conducts rapid due diligence, leveraging a common set of tools and industry metrics to deliver indicative prices and risk impacts. These are then monetized into an incremental bid or acquisition prices using a standardized Leveraged Buy-Out financial model developed and maintained by Proactive Business Development. The offerings for this channel are also segmented based on the phase of the opportunity being pursued by the PE firm—due diligence, pre-closing (between successful selection under an auction process and acquisition closing) and post acquisition with defined deliverables at each stage of the process. This allows a PE firm flexibility to make a selection where it needs assistance.

The Proactive Business Development center of competency 301 also aligns the investment banker engagement model 403 to fulfill strategic needs of a company. Banks are pre-selected based on their financial advisory capabilities, deal experience and other commercial relationships with the company using a standard comparison scoring template. Based on guidance provided by the Proactive Development center of competency, these short-listed banks are then expected to provide strategic and opportunistic market insights. The template for guidance is typically completed by a sponsoring business line executive seeking those kinds of strategic inputs. If valued, these strategic exercises would be the basis for selecting an investment bank as an advisor for an acquisition.

Venture Capital Coverage 405 involves a business and financial framework to identify a set of select Venture Capital firms as strategic partners. Core to the partnership value is using these relationships to create common go-to-market strategies with portfolio companies of the funds and sell through of a company's product. Additionally, these Select Venture Capital firms become sources of technology innovation insights and influencers in a company's acquisitions out of those respective portfolios. This commitment to the company's product platform and partnership becomes the basis for financial investments in the funds and the assignment of a senior sales representative from a company to act as a relationship cover for each Venture Capital firm. This representative has a reporting line into Proactive Business Development for oversight and governance.

The Proactive Business Development center of competency 301 also manages the Growth through Acquisitions and Partnership (GAP) Program 406. GAP is both a framework for inorganic growth, as well as a vendor selection service to help create complete solutions that enhance a company's offerings and capabilities. The GAP framework utilizes developed models and a structured dialog between sponsoring management and external influencers to identify missing pieces in solutions and strategies. The framework assists the management team in identifying leading areas for non-organic growth opportunities, and helps them formulate a strategy and structure for engaging with external partners.

The GAP service 406 begins with the creation of a specifications sheet, which specifies the business unit need, the requirements the potential partner must achieve to qualify, and desired capabilities the sponsoring team needs. A list of potentials is then developed by exploiting the network of venture capitalists, investment banks, and private equity firms 402. Designated resources from the Proactive Business Development center of competency 301 and business unit assist the sponsor to evaluate and prioritize candidates, and then facilitate discussions between the business unit and leading contenders. After candidates are selected, this team helps the business unit engage the appropriate business development group to provide deeper due diligence and, ultimately, form a partnership or acquisition.

Any target for acquisitions identified through Proactive Business Development 301 activities or any other avenues must be brought forward for Concept Approval 701 before the M&A deal can proceed. The Concept Approval process is discussed in more detail below.

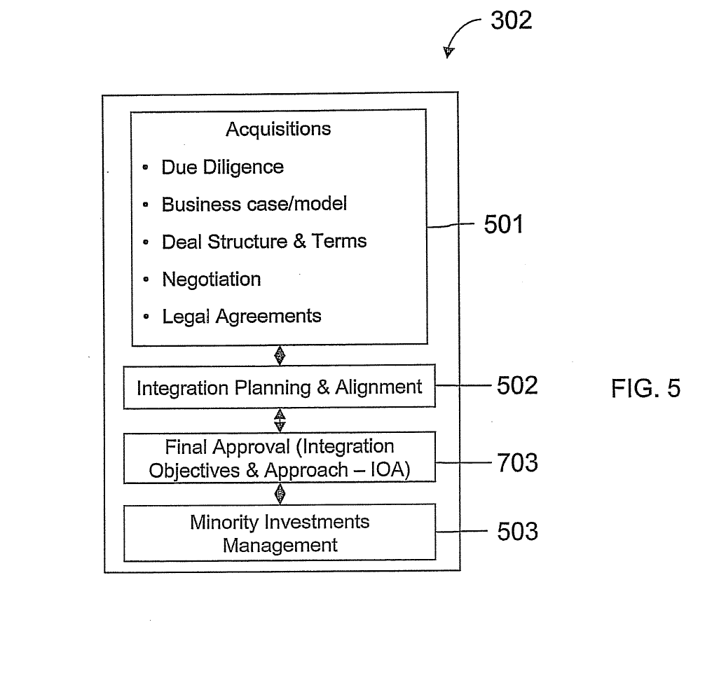

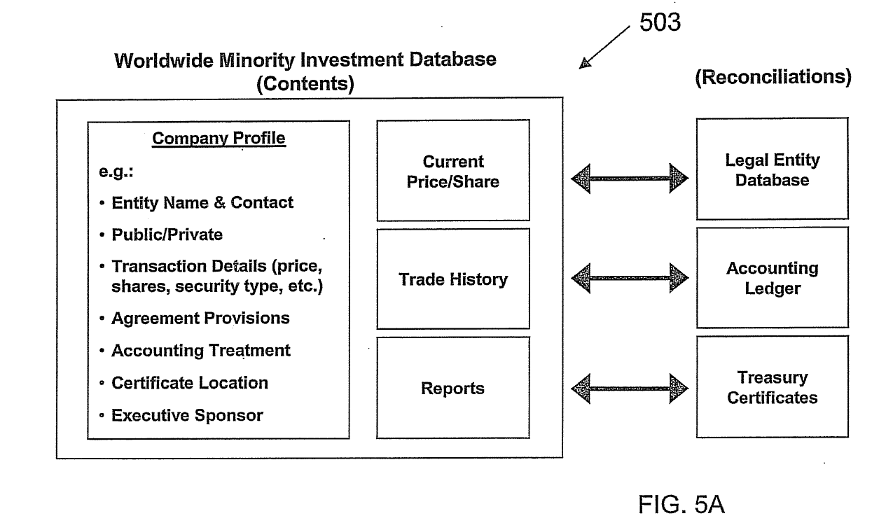

Transaction Execution 302 supports the Transaction phase by managing the deal from Concept Approval to Final Approval. The Transaction Execution and Acquisition Integration centers of competency work in partnership to establish a solid platform for integration 305 during this phase of the M&A lifecycle. FIG. 5 illustrates the processes and key activities in which the Transaction Execution center of competency is engaged in executing or overseeing.

The Transaction Execution center of competency provides various services 501 to the business unit to drive the deal from the Concept Approval step to Final Approval. Transaction Execution resources manage and oversee the Due Diligence process, including resolution of key issues, they maintain a standard financial model on which the business case/model is developed, they structure and negotiate the terms of deal on behalf of the business, and develop and maintain all related legal documentation. In addition, they partner with resources in the Acquisition Integration center of competency work and in the sponsoring part of the business in Integration Planning and Alignment 502 in preparation for Final Approval 703 where the integration plan will be reviewed and approved.

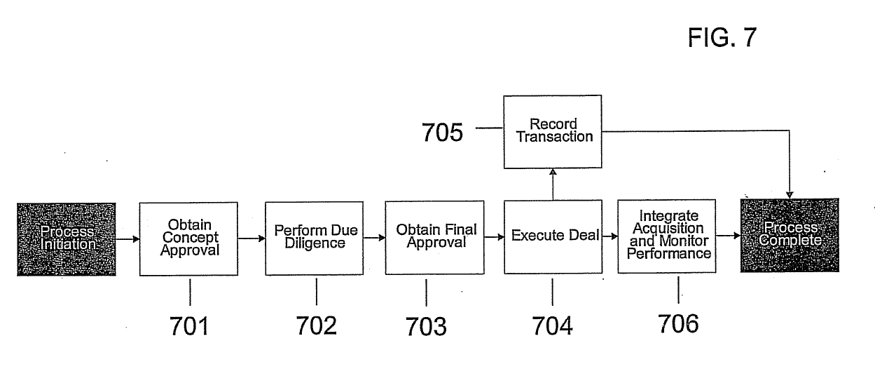

] The specific methods and systems associated with the services provided by the Transaction Execution center of competency 501 are described in detail as part of FIGS. 7 to 11.

Once a business unit/sponsor determines it would like to proceed with an acquisition, it must be brought forward for Final Approval 703. The Final Approval process is discussed in more detail below.

The Transaction Execution center of competency also manages all minority investments 503. It collects key data, enables informed decision making, and increases visibility into potential exposures and risks relating to these minority investments. Examples of minority investment activity could include, but are not limited to, nominal direct cash or in-kind investments in early stage companies as part of emerging market initiatives, stock/warrants received as part of an alliance, warrants received to balance debt financing risk, or periodic stock distributions from venture funds.

Minority investments are tracked in a Worldwide Minority Investment Tracking Database (FIG. 5a). The Worldwide Minority Database is a centralized information source for tax, accounting, legal and business development executives. The database is populated with executed equity transactions. The database provides a current balance of minority investment portfolio by business unit and geography, a comprehensive repository of minority investments, an effective mechanism by which legal, accounting and business events related to the investment can be tracked and implications analyzed, portfolio administration and gain/loss tracking tool for publicly traded securities, and a resource for senior management reporting. The database captures key business and financial information about the minority investment. In addition, it tracks current market value, and sale related actions. Automated report generation allows for the ease of viewing the portfolio on an aggregate basis. Reconciliation of the database contents against other accounting and legal systems ensure information accuracy. Reconciliations are typically performed by Accounting, Treasury and Corporate Development departments.

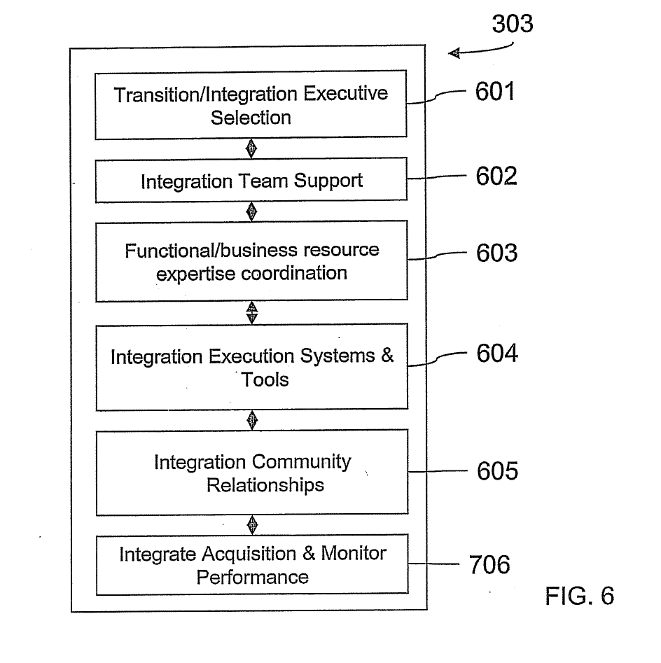

In addition to supporting Integration Planning and Alignment, the Acquisition Integration center of competency 303 enables the business to integrate acquired companies and tracks acquisition performance against defined business case targets and leading indicator milestones. FIG. 6 illustrates the specific processes and key activities in which the Acquisition Integration center of competency is engaged in executing.

The Acquisition Integration center of competency 303 participates in the selection of the Transition/Integration Executive (TE) 601 who will be responsible for integrating the acquired company and for delivering on the deal business case. Resources representing this center of competency first meet with the acquisitions executive sponsor to ensure a common understanding of the role of the TE and to help ensure selection of an appropriate candidate. Often they will then meet with the potential candidate selected by the executive sponsor to discuss the role in more detail prior the candidate selecting the position. Once the candidate has accepted the role of the TE, the Acquisition Integration center of competency resources will hold an introductory meeting with the new leader of the integration.

A first key element of Integration Team Support (602 involves conducting a Transition Executive “Bootcamp”. This “bootcamp” typically involves interaction between Acquisition Integration center of competency resources, the TE, and often the Project or Program Manager resource assigned to the integration to support the TE. The “bootcamp” is an opportunity to share with the new leader of the integration all the key Integration Execution Systems and Tools 604 developed and maintained by the Acquisition Integration center of competency as well as the knowledge held by its representatives.

The prime objective of the “bootcamp” is to prepare the TE for their immediate responsibilities, including: (a) develop a transition and integration roadmap (program plan) with a focus on the first 100 days post close, (b) create the “must make” milestones linked to the acquisitions strategic rationale, business case, and value drivers, (c) ensure all necessary execution resources are dedicated and/or named, (d) establish, host work sessions (integration kick-off/team meetings) to ensure responsibilities are understood and program management, performance measures, schedules, and status reporting feedback mechanisms are in place, (e) launch integration planning work efforts across all functional areas and geographies.

In addition, particularly if the TE is named after Due Diligence, the Acquisition Integration center of competency plays a critical role in connecting the TE to key resources in the Transaction Execution center of competency to ensure the TE properly understands the business case/model and related assumptions as well as any issues that surfaced during Due Diligence. Ideally, the TE is selected early enough to participate directly in Due Diligence, the development of the Business Case/Model, Integration Planning and Alignment, and will actually present the integration plan for Final Approval 703.

The Acquisition Integration center of competency helps the TE create a team to execute the integration on their behalf by coordinating access to key functional/business resource expertise 603 retained in the various organizational functional areas and business units. Integration Team Support 602 is provided on an as needed basis depending on the complexity of the acquisition, the experience of the team in integration, and the speed with which the acquisition is expected to close.

The Acquisition Integration center of competency develops and maintains Integration Execution Systems and Tools 604 to enable a repeatable process that incorporates learning from prior acquisitions. Integration Community Relationships 605 with integration experts provide ongoing input to these systems and tools and assist in issue resolution. It fosters these relationships through regular meeting interaction and by hosting and participating in conferences and workshops on key integration topics.

The Acquisition Integration center of competency also monitors and reports on the performance of each acquisition against defined business case targets and leading indicator milestones 706. This process is discussed in more detail below. It also communicates key learning points to the other centers of competency involved in earlier phases of the M&A lifecycle 306. This ensures continuous improvement in the selection of appropriate targets and in the early identification of integration risks that might undermine future deal value and success.

FIG. 7 illustrates the deal management system that underpins the complete and integrated approach to the M&A lifecycle once a target for acquisition has been identified. While methods described herein refer to specific roles and responsibilities in the process for particular organizational units, there is no requirement that these units perform the prescribed steps in the processes, only that the steps are completed in an integrated manner. Organizational structures can vary dramatically and each company would assign parts of the process to business units within its structure as appropriate. Key to the process, however, is a consistent executive decision panel—the “Deal Committee”. The Deal Committee is made up of key leadership and can include, but is not limited to, key individuals such as Chief Financial Officer (CFO), lead Corporate Development Executive, General Counsel, lead Human Resources Executive, Corporate Strategy Leader, and Financial Controller.

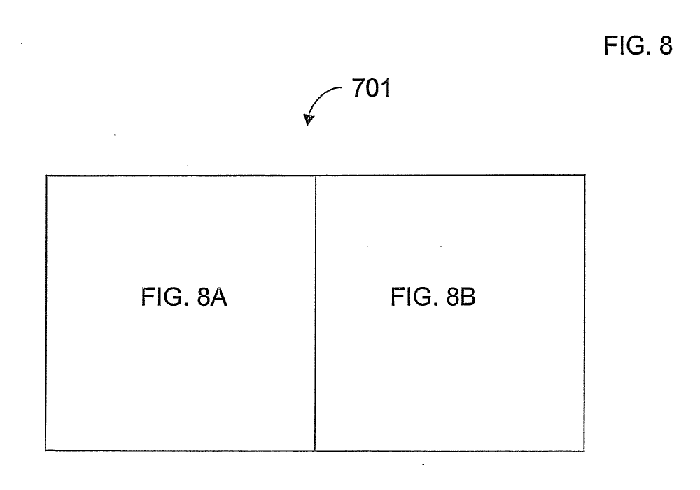

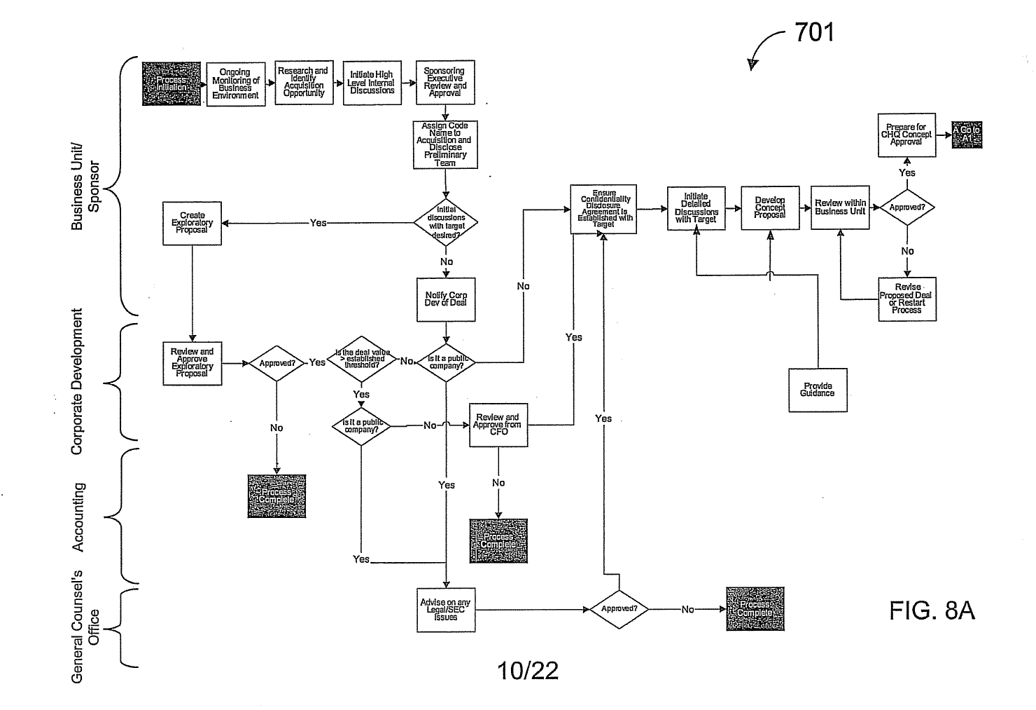

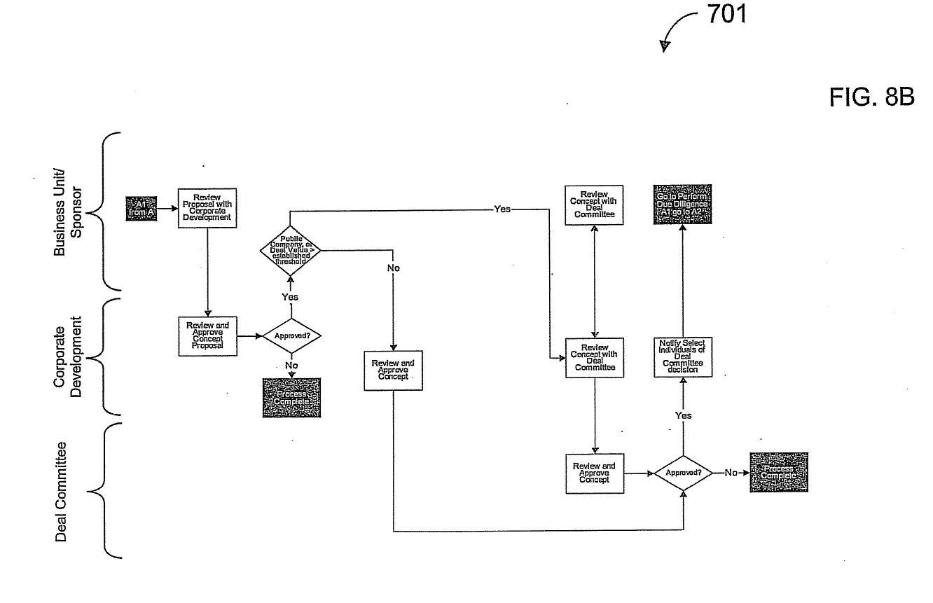

Concept Approval 701, as illustrated in FIG. 8A and FIG. 8B, is the process by which a sponsoring unit first requests approval to initiate discussions with a company (or multiple companies) regarding an equity based relationship—the objective being to assess the other parties interest level and to collect more information. The target company or companies are identified as the result of ongoing monitoring of the business environment and the work of the Proactive Business Development center of competency. The sponsoring business unit identifies an Executive Sponsor to own the opportunity and provide business unit approval to proceed with the process.

Early in this process, M&A deals are assigned code names to protect the identity of the acquisition target. As the deal team expands, individuals are notified, disclosed, and reminded of their responsibilities relative to the non-disclosure process and business controls guidelines for employees.

If initial discussions with the target are desired, the deal sponsor(s) will prepare an “Exploratory Proposal” for approval by the Transaction Execution center of competency (typically part of a corporate development department). Exploratory approval is sought by the business units even when an approved strategy exists as a first step in the overall Concept Approval process.

If approved, a confidentiality disclosure agreement is established with the target. Prior to this step, CFO approval is required for potential investments above an established dollar threshold amount (this would vary between companies implementing this process). General Counsel must advise on any potential SEC or other legal issues and approve the deal if the target is a public company.

If detailed discussions with a potential target company result in a desire to proceed with an M&A deal, a specific “Concept Proposal” is created and presented for approval. Focus items for the Concept Proposal include a description of the product or service area, description of the opportunity, statement on the fit with overall company strategy, analysis of market players and positions, analysis of gaps and weaknesses in our company as compared to the opportunity, statement of other alternatives to the proposed deal, discussion about candidates, statement about preferred target and the rationale for selection, listing of current relationship if any with the target, summary financial information, and the vision for the integration.

The Concept Proposal is first approved within the sponsoring business unit and then submitted to the Transaction Execution center of competency (typically part of a corporate development department) for approval. All Concept Proposals for public companies or for deals greater than an established dollar threshold are submitted to Deal Committee for approval.

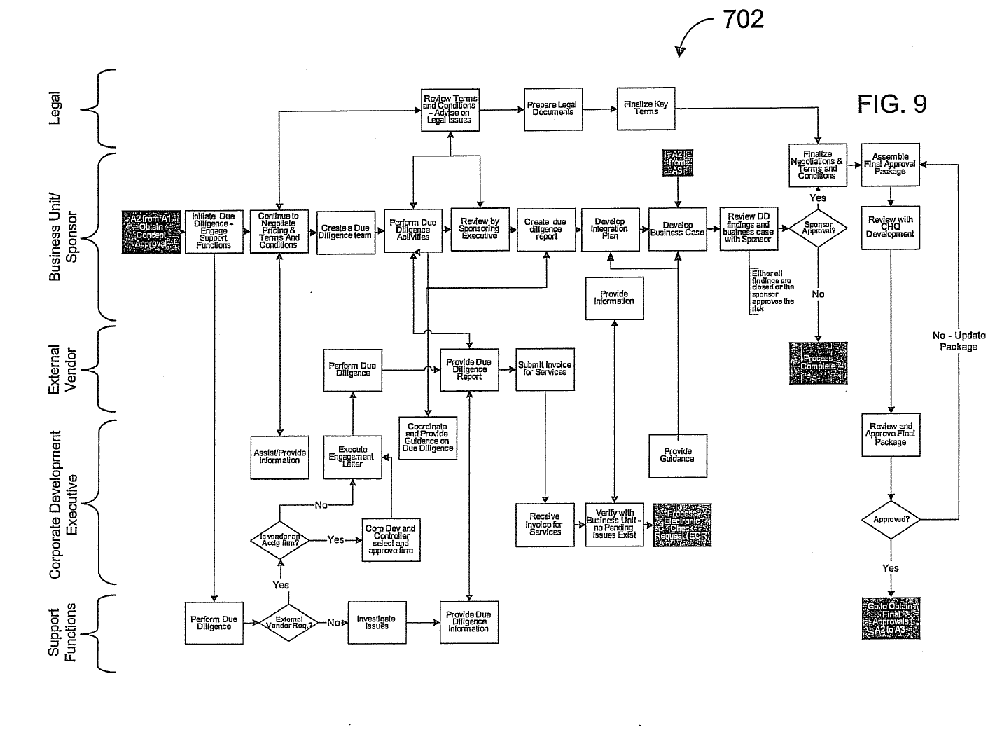

As illustrated in FIG. 9, Due Diligence 702 can begin once Concept Approval is granted. The first step is to create a Due Diligence team and to engage specific Support Functions to participate. Support functions (i.e., Real Estate, Human Resources, IT Infrastructure, etc.) participate in Due Diligence to perform legal and operational risk assessments and to provide cost assumptions (i.e., building refit, retention plans, new technology hardware requirements, etc.) that must be considering in developing the business case. If required, external vendors, such as accounting firms, are retained to provide supplemental support.

While the deal pricing and terms and conditions are being negotiated, formal Due Diligence activities are conducted. Formal Due Diligence is conducted using standard checklists established for the type of company and based on the strategic requirements and assumptions that must be validated on behalf of the sponsoring business unit. This formal step is usually conducted with all members of the team in person in the city in which the target company in based.

Part of the Due Diligence process involves the validating the assumptions in the financial Business Case/Model. All business cases are developed using a consistent, established financial model developed and maintained by the Transaction Execution center of competency.

A comprehensive Due Diligence report is created which captures all critical findings relating to the target company and any impacts of these finding on the potential value of the deal or risks to integration. The report incorporates findings from the sponsoring business unit, Support Functions, Legal, and any external vendors. The report is reviewed by the sponsoring business unit and provides input to Legal as they advise on issues relating to contractual terms and conditions.

While Legal prepares legal documents and finalizes key terms in partnership with the sponsoring business unit, the business unit begins to develop an integration plan and final business case based on the findings from Due Diligence with input from the Transaction and Acquisition Integration centers of competencies.

Due Diligence findings are either resolved or their associated risks are approved by the deal sponsor if they wish to proceed with the deal. Final terms and conditions are negotiated while the sponsoring business unit prepares a package for Final Approval to proceed with the deal.

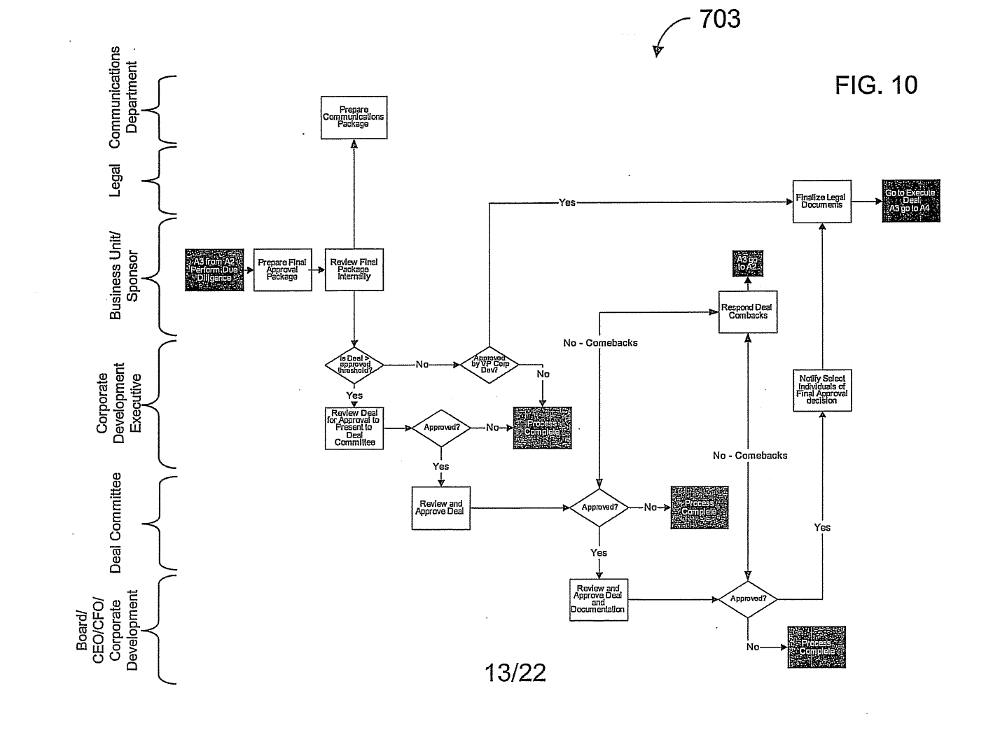

Final Approval 703, as illustrated in FIG. 10, is the process by which a sponsoring unit requests approval to execute the deal. The integration package prepared for the Final Approval meeting with the Deal Committee as for Concept Approval) is called the Integration Objectives and Approach (IOA) document. The expectations are appropriately more rigorous compared with those for Concept Approval.

Focus items which make up the final deal package include a description of the product or service area, description of the opportunity, statement on the fit with overall company strategy, analysis of market players and positions, analysis of gaps and weaknesses in the company as compared to the opportunity, statement of other alternatives to the proposed deal, discussion about candidates, statement about preferred target and the rationale for selection, listing of current relationship if any with the target, Due Diligence issues, key deal structure, points under negotiation, complete and rigorous financial analysis/valuation, all financial statements, committed financial business case financial plan, and a detailed integration plan including key milestones in each functional and business area required to integrate the acquired company and meet financial and strategic objectives.

The Final Approval package goes through rigorous reviews in the business unit prior to being submitted. Deals greater than the established dollar threshold go to Deal Committee for approval. Others can be approved by the lead Corporate Development Executive or other designate. “Comebacks” on the Final Approval package may be required to either Deal Committee or lead Corporate Development Executive or other designate if they deem the package incomplete.

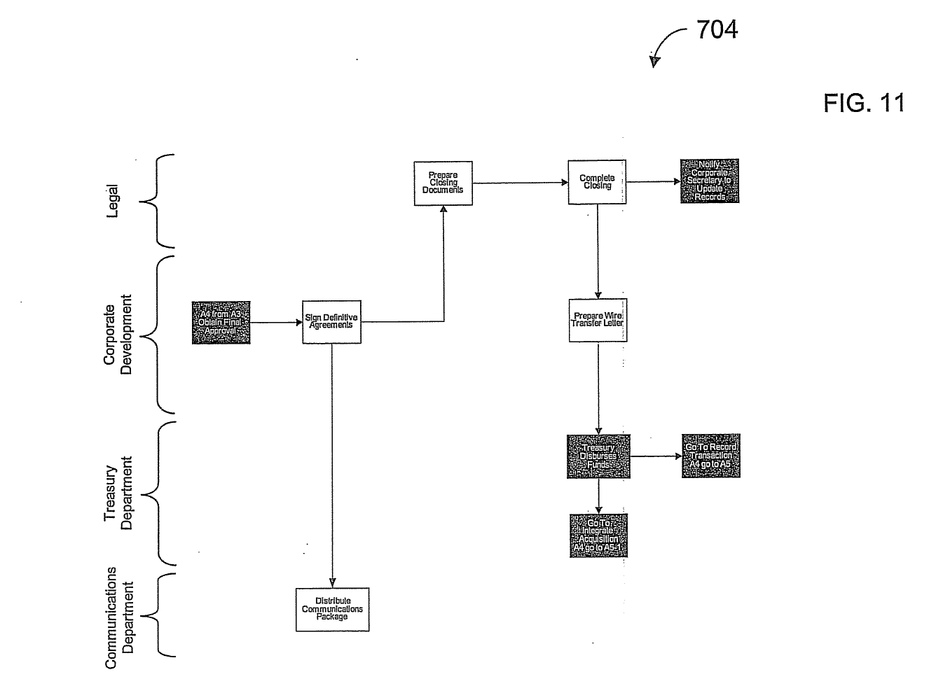

Once Final Approval is obtained, executive sponsors may move forward to finalize legal documents and sign definitive agreements for the deal 704 as shown in FIG. 11. The approved delegate signs for all acquisitions once final approval have been obtained and Legal has reviewed the final definitive agreements. Internal and external communications are distributed as required. Timing of communications is variable and can occur at Signing or Closing of the transaction. There are also instances where no external communication is necessary.

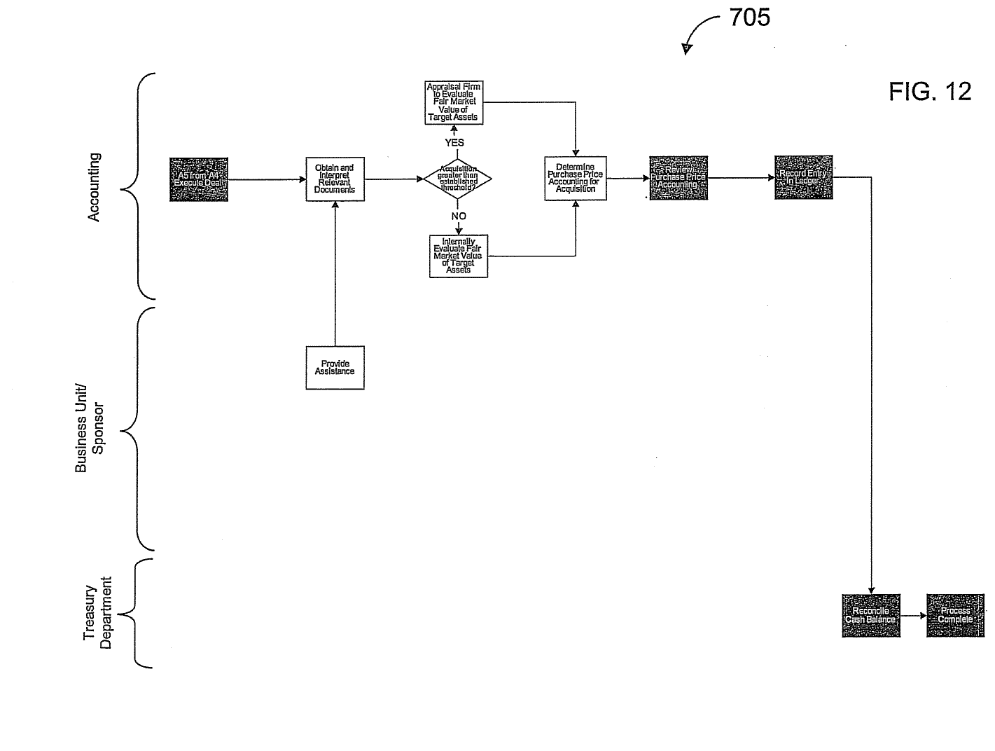

The transaction can then be Recorded 705 as appropriate by the Accounting organization(s) as show in FIG. 12. Accounting reviews the relevant documents and evaluates the fair market value of the target assets to determine appropriate purchase price accounting for the acquisition. Purchase price accounting is reviewed by designated accounting analysts in the respective transactions geography to ensure it is accurate. Records are then entered and reconciled in the appropriate systems.

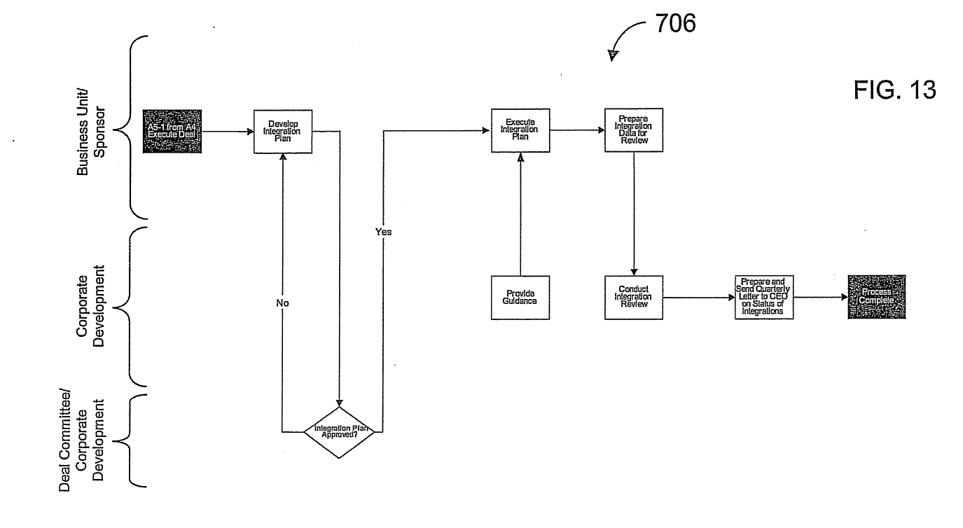

After the deal has Signed or Closed, more detailed integration planning can occur based on the initial integration plan is developed for Final Approval. As shown in FIG. 13 706, this plan is then executed to integrate the acquired company. The point of integration and most of the work to execute is typically conducted and coordinated by the sponsoring business unit with support and guidance from the Acquisition Integration center of competency. The Acquisition Integration center of competency (and typically Corporate Development) is also involved in monitoring and evaluating the ongoing performance of the acquisition through integration reviews, including Monthly Checkpoints and formal Quarterly Reviews.

Monthly Checkpoints on deals are conducted for the initial months between the close of the deal and the first quarterly review. The Monthly Checkpoint is an informal meeting where no official evaluation of business case attainment and integration progress is made. The objective of the Monthly Checkpoints are to ensure proper support is in place to execute a fast start on transition activities and to provide a forum where Transition Executives (TEs) can communicate issues early and solicit support for resolution. The Monthly Checkpoints typically begin the first month after the deal close and continue until the first quarterly tracking sessions. Additional Monthly Checkpoints maybe added after the first quarterly performance review if there are ongoing issues requiring focus. Participants in the meeting include the TE and Executive Sponsor, and support (as needed) from business unit finance and operational representatives.

Quarterly Reviews are the formal process whereby acquisition progress to date is evaluated. The objective of the Quarterly Review is to ensure that all key parties (i.e., Executive Sponsor, lead Corporate Development executive, etc.) are aware of the integration progress and transition execution as compared to the approved business case commitments and integration strategy to ensure timely issue and risk management with senior management. In addition, it facilitates improved knowledge management and lessons learned captured on a regular basis that feed into the Strategy and Transactions phase for future deals.

A quarterly tracking database gathers and consolidates quarterly financial measurements and tracking milestones in a central repository for all acquisitions to ensure that measurements are consistent across acquisitions. Quarterly Review meetings are held (typically with the lead Corporate Development Executive and key representatives from the Acquisition Integration center of competency) to provides qualitative discussion and insights on integration specific performance measurements. Quarterly Reviews begin the first full quarter after close and continue for a total of eight consecutive quarters.

Each quarter, input from the tracking database and Quarterly Review meetings is used to assess the overall performance rating for the acquisition which is included with written commentary in a quarterly letter to the senior executives (i.e., CEO, CFO, etc.).

Hardware/Software Implementation

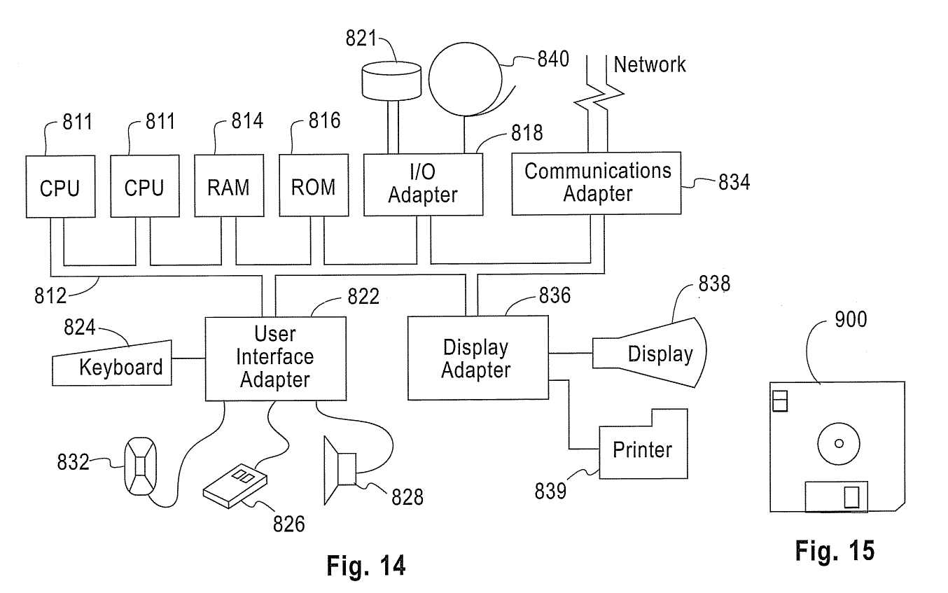

FIG. 14 illustrates a typical hardware configuration of an information handling/computer system 800 usable with the present invention, as described later, and which computer system preferably has at least one processor or central processing unit (CPU) 811. In the exemplary architecture of FIG. 14, the CPUs 811 are interconnected via a system bus 812 to a random access memory (RAM) 814, read-only memory (ROM) 816, input/output (I/O) adapter 818 (for connecting devices such as disk units or servers 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the invention.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 15), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

Another aspect of the present invention can be embodied in a number of variations, as will be obvious once the present invention is understood. That is, the methods of the present invention could be embodied as a computerized tool stored on diskette 800 that contains a series of matrix subroutines to solve scientific and engineering problems using matrix processing in accordance with the present invention. Alternatively, diskette 900 could contain a series of subroutines that allow an existing tool stored elsewhere (e.g., on a CD-ROM) to be modified to incorporate one or more of the principles of the present invention.

Additional aspects of the present invention allows for general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

Moreover, the principles and methods of the present invention could be embodied as a computerized tool stored on a memory device, such as independent diskette 900, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module.

It should also be obvious to one of skill in the art that the instructions for the technique described herein can be downloaded through a network interface from a remote storage facility or server.

Software Deployment

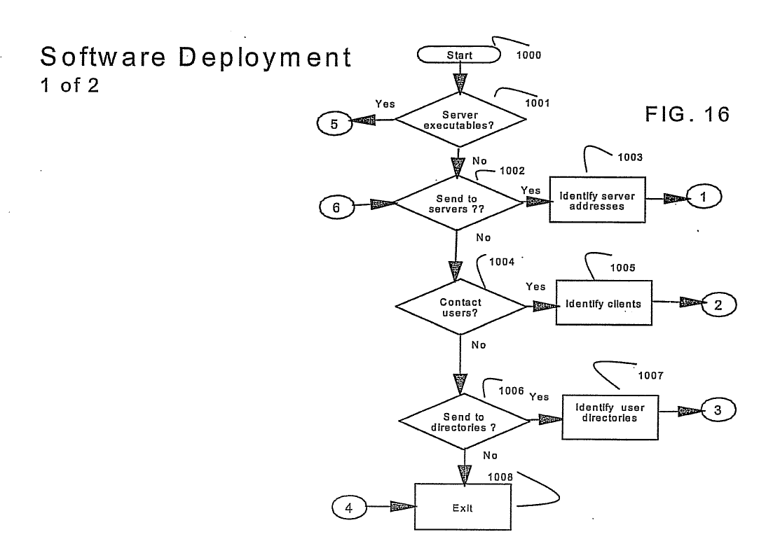

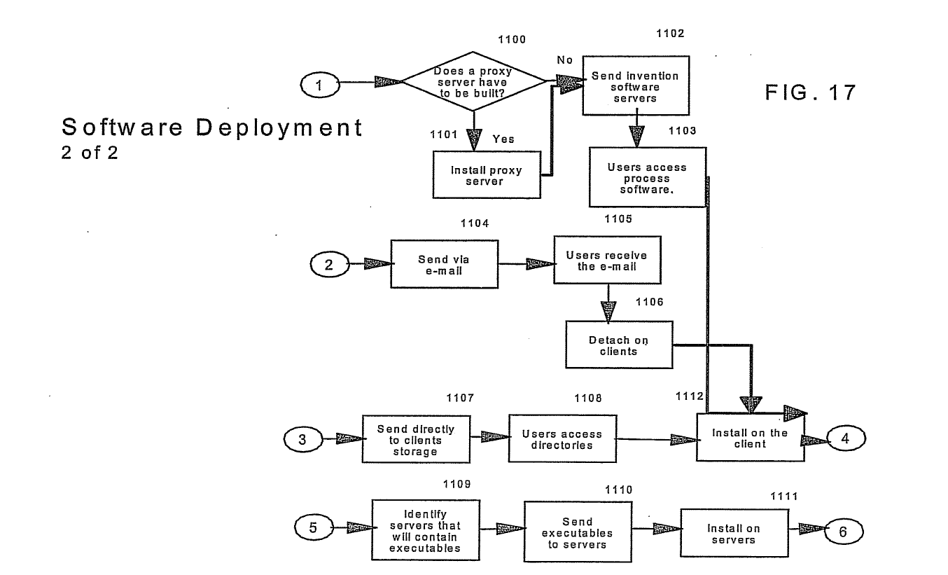

FIGS. 16 and 17 illustrate a software deployment implementation for using an integrated approach in an end-to-end process according to an embodiment of the present invention. Step 1000 begins the deployment of the process software. The first thing is to determine if there are any programs that will reside on a server or servers when the process software is executed 1001. If this is the case then the servers that will contain the executables are identified 1109. The process software for the server or servers is transferred directly to the servers' storage via FTP or some other protocol or by copying though the use of a shared file system 1110. The process software is then installed on the servers 1111.

Next, a determination is made on whether the process software is be deployed by having users access the process software on a server or servers 1002. If the users are to access the process software on servers then the server addresses that will store the process software are identified 1003.

A determination is made if a proxy server is to be built 1100 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 1101. The process software is sent to the servers either via a protocol such as FTP or it is copied directly from the source files to the server files via file sharing 1102. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 1103. Another embodiment is to have the servers automatically copy the process software to each client and then run the installation program for the process software at each client computer. The user executes the program that installs the process software on his client computer 1112 then exits the process 1008.

In step 1004 a determination is made whether the process software is to be deployed by sending the process software to users via e-mail. The set of users where the process software will be deployed are identified together with the addresses of the user client computers 1005. The process software is sent via e-mail to each of the users' client computers. The users then receive the e-mail 1105 and then detach the process software from the e-mail to a directory on their client computers 1106. The user executes the program that installs the process software on his client computer 1112 then exits the process 1008.

Lastly a determination is made on whether to the process software will be sent directly to user directories on their client computers 1006. If so, the user directories are identified 1007. The process software is transferred directly to the user's client computer directory 1107. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 1108. The user executes the program that installs the process software on his client computer 1112 then exits the process 1008.

VPN Deployment

The present software can be deployed to third parties as part of a service wherein a third party VPN service is offered as a secure deployment vehicle or wherein a VPN is build on-demand as required for a specific deployment. A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

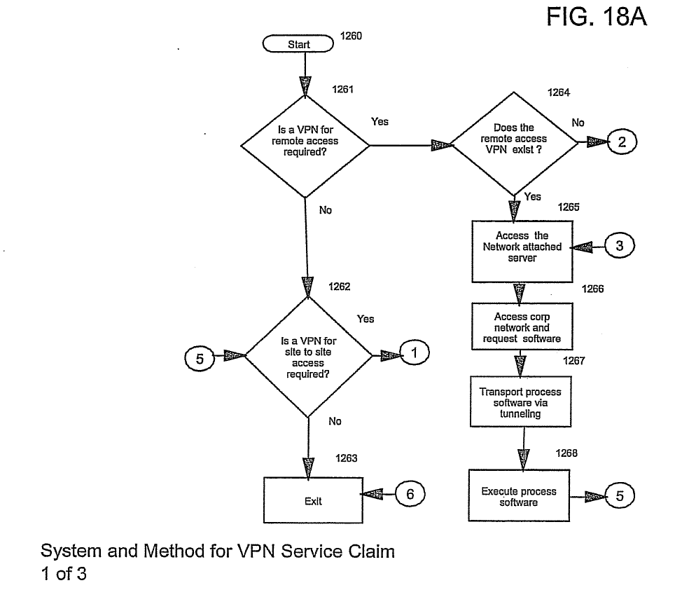

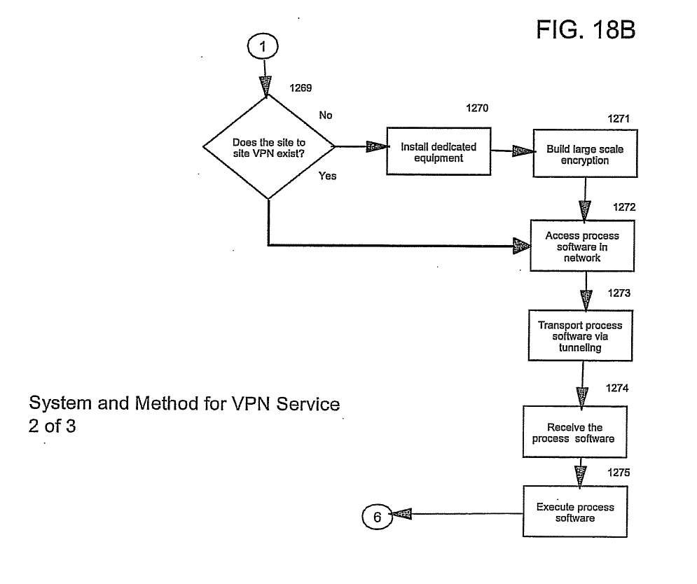

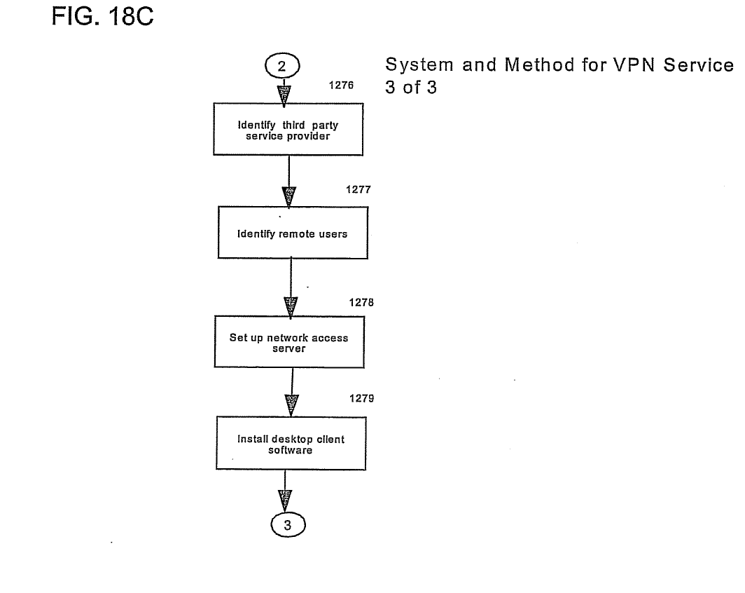

FIGS. 18A, 18B and 18C illustrate the VPN software deployment implementation for using an integrated approach in an end-to-end process according to an embodiment of the present invention. Step 1260 begins the Virtual Private Network (VPN) process. A determination is made to see if a VPN for remote access is required 1261. If it is not required, then proceed to 1262. If it is required, then determine if the remote access VPN exists 1264.

If a VPN does exist, then proceed to 1265. Otherwise identify a third party provider that will provide the secure, encrypted connections between the company's private network and the company's remote users 1276. The company's remote users are identified 1277. The third party provider then sets up a network access server (NAS) 1278 that allows the remote users to dial a toll free number or attach directly via a broadband modem to access, download and install the desktop client software for the remote-access VPN 1279.

After the remote access VPN has been built or if it been previously installed, the remote users can access the process software by dialing into the NAS or attaching directly via a cable or DSL modem into the NAS 1265. This allows entry into the corporate network where the process software is accessed 1266. The process software is transported to the remote user's desktop over the network via tunneling. That is the process software is divided into packets and each packet including the data and protocol is placed within another packet 1267. When the process software arrives at the remote user's desktop, it is removed from the packets, reconstituted and then is executed on the remote users desktop 1268.

A determination is made to see if a VPN for site to site access is required 1262. If it is not required, then proceed to exit the process 1263. Otherwise, determine if the site to site VPN exists 1269. If it does exist, then proceed to 1272. Otherwise, install the dedicated equipment required to establish a site to site VPN 1270. Then build the large scale encryption into the VPN 271.

After the site to site VPN has been built or if it had been previously established, the users access the process software via the VPN 1272. The process software is transported to the site users over the network via tunneling. That is the process software is divided into packets and each packet including the data and protocol is placed within another packet 1274. When the process software arrives at the remote user's desktop, it is removed from the packets, reconstituted and is executed on the site users desktop 1275. Proceed to exit the process 1263.

It is to be understood that the provided illustrative examples are by no means exhaustive of the many possible uses for my invention.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the embodiments described above, but encompasses any and all embodiments within the scope of the following claims:

We claim:

1. A method of an integrated approach in a business environment, said method comprising:
developing an end-to-end process for managing acquisitions including, developing strategies and identify an appropriate company for acquisition, managing a transaction and negotiating a deal, integrating an acquired acquisition, and tracking performance against defined business case targets and milestones.

2. The method according to claim 1, wherein said developing strategies further comprises:
creating a proactive business development plan.

3. The method according to claim 2, wherein said creating a proactive business development plan comprises:
developing a market insight for an area of interest;
using an investment banking ecosystem;
conducting a GAP analysis; and
identifying any possible adjacent spaces for development.

4. The method according to claim 2, wherein said creating a proactive business development plan comprises:
conducting a GAP analysis; and
presenting a selected acquisition for concept approval.

5. The method according to claim 1, wherein said creating a proactive business development plan comprises:
conducting an overall fit and alignment assessment for a selected acquisition.

6. The method according to claim 1, wherein said managing a transaction and negotiating a deal further comprises:
using a transaction execution center to provide various services thereby enabling a business unit to perform the necessary steps from concept approval to final approval.

7. The method according to claim 6, wherein said transaction execution center further comprises a method of:
conducting a due diligence process;
developing a business case and model;
structuring and negotiating the terms of a transaction; and
developing and maintaining all agreements for said transaction.

8. The method according to claim 6, wherein said managing a transaction and negotiating a deal further comprises the method of:
using an integration objectives and approach (IOA) tool as part of a final approval process.

9. The method according to claim 1, wherein said managing a transaction and negotiating a deal further comprises the method of:
using an integration objectives and approach (IOA) tool as part of a final approval process.

10. The method according to claim 1, wherein said managing a transaction and negotiating a deal further comprises the method of:
using a minority investment database.

11. The method according to claim 1, wherein said integrating an acquired acquisition, and tracking performance against defined business case targets and milestones further comprises the method of:
using an acquisition integration center to provide various services thereby enabling a business unit to perform the necessary acquisition steps from concept approval to final approval.

12. The method according to claim 11, wherein said acquisition integration center further comprises a method of:
selecting an integration executive for integrating the acquired company and for creating deliverables supporting a business case.

13. The method according to claim 12, wherein said selecting an integration executive further comprises:
using integration team support elements including conducting a transition executive bootcamp.

14. The method according to claim 12, wherein said selecting an integration executive further comprises:
using functional resource expertise retained in various organizational functional areas and business units.

15. The method according to claim 12, wherein said selecting an integration executive further comprises:
using integration execution systems and tools to enable a repeatable process that incorporates information learned from prior acquisitions.

16. The method according to claim 12, wherein said selecting an integration executive further comprises:
using integration community relationships with integration experts to provide ongoing input and assist in issue resolution.

17. A system comprising:
at least one host computer, said at least one host computer operative to:
develop an end-to-end process for managing acquisitions including, develop strategies and identify an appropriate company for acquisition, manage a transaction and negotiating a deal, integrate an acquired acquisition, and track performance against defined business case targets and milestones.

18. The system according to claim 17, wherein said developed strategies further comprises:
a proactive business development plan.

19. The system according to claim 18, wherein said proactive business development plan comprises:
a market insight for an area of interest;
an investment banking ecosystem;
a GAP analysis; and
means for identifying any possible adjacent spaces for development.

20. The system according to claim 18, wherein said proactive business development plan comprises:
a GAP analysis; and
a selected acquisition for concept approval.

21. The system according to claim 17, wherein said proactive business development plan comprises:
an overall fit and alignment assessment for a selected acquisition.

22. The system according to claim 17, wherein said managed transaction and negotiated deal further comprises:
a transaction execution center to provide various services thereby enabling a business unit to perform the necessary steps from concept approval to final approval.

23. The system according to claim 22, wherein said transaction execution center further comprises:
a due diligence process;
a business case and model;
structure and negotiated the terms for said transaction; and
means for developing and maintaining all agreements for said transaction.

24. The system according to claim 22, wherein said managed transaction and negotiated deal further comprises:
an integration objectives and approach (IOA) tool as part of a final approval process.

25. The system according to claim 17, wherein said managed transaction and negotiated deal further comprises:
an integration objectives and approach (IOA) tool as part of a final approval process.

26. The system according to claim 17, wherein said managed transaction and negotiated deal further comprises:
a minority investment database.

27. The system according to claim 17, wherein said integrated acquired acquisition further comprises:
an acquisition integration center to provide various services thereby enabling a business unit to perform the necessary acquisition steps from concept approval to final approval.

28. The system according to claim 27, wherein said acquisition integration center further comprises:
an integration executive for integrating the acquired company and for creating deliverables supporting a business case.

29. The system according to claim 28, wherein said integration executive further comprises:
integration team support using tools including a transition executive bootcamp.

30. The system according to claim 28, wherein said integration executive further comprises:
a functional resource expert for various organizational functional areas and business units.

31. The system according to claim 28, wherein said integration executive further comprises:
integration execution systems and tools to enable a repeatable process that incorporates information learned from prior acquisitions.

32. The system according to claim 28, wherein said integration executive further comprises:
means for using integration community relationships with integration experts to provide ongoing input and to assist in issue resolution.

33. A computer program product comprising a computer usable medium program including a computer readable program, wherein the computer readable program when executed on a computer causes the computer to implement a method, the method comprising:
developing an end-to-end process for managing acquisitions including, developing strategies and identify an appropriate company for acquisition, managing a transaction and negotiating a deal, integrating an acquired acquisition, and tracking performance against defined business case targets and milestones.

34. The computer program product according to claim 39, wherein said developing strategies further comprises:
creating a proactive business development plan.

35. The computer program product according to claim 33, wherein said managing a transaction and negotiating a deal further comprises:
using a transaction execution center to provide various services thereby enabling a business unit to perform the necessary steps from concept approval to final approval.

36. The computer program product according to claim 35, wherein said transaction execution center further comprises a method of:
conducting a due diligence process;
developing a business case and model;
structuring and negotiating the terms of a transaction; and
developing and maintaining all agreements for said transaction.

37. The computer program product according to claim 33, wherein said managing a transaction and negotiating a deal further comprises the method of: using an integration objectives and approach (IOA) tool as part of a final approval process.

38. The computer program product according to claim 33, wherein said managing a transaction and negotiating a deal further comprises the method of using a minority investment database.

39. The computer program product according to claim 33, wherein said integrating an acquired acquisition, and tracking performance against defined business case targets and milestones further comprises the method of:
using an acquisition integration center to provide various services thereby enabling a business unit to perform the necessary acquisition steps from concept approval to final approval.

40. The computer program product according to claim 39, wherein said acquisition integration center further comprises a method of:
selecting an integration executive for integrating the acquired company and for creating deliverables supporting a business case.

41. Implementing a service in a business environment comprising the method of: developing an end-to-end process for managing acquisitions including, developing strategies and identify an appropriate company for acquisition, managing a transaction and negotiating a deal, integrating an acquired acquisition, and tracking performance against defined business case targets and milestones.

42. The implementation according to claim 41, wherein said managing a transaction and negotiating a deal further comprises the method of:
using an integration objectives and approach (IOA) tool as part of a final approval process.

43. The implementation according to claim 41, wherein said developing strategies further comprises the method of:
partnering with Private Equity.
